(19) United States
(12) Patent Application Publication
(10) Pub. No.: US 2020/0058024 A1
(43) Pub. Date: Feb. 20, 2020

(54) METHOD AND SYSTEM FOR AUTOMATICALLY RECEIVING AND/OR EMITTING INFORMATION RELATED TO TRANSACTIONS

(71) Applicant: GEMALTO SA, Meudon (FR)

(72) Inventors: Marc MULLER, Gemenos (FR); Sylvie GIBERT, Gemenos (FR); Serge BARBE, Gemenos (FR)

(73) Assignee: GEMALTO SA, Meudon (FR)

(21) Appl. No.: 16/344,487

(22) PCT Filed: Oct. 20, 2017
(86) PCT No.: PCT/EP2017/076819

§ 371 Date: Apr. 24, 2019

(30) Foreign Application Priority Data
Oct. 27, 2016 (EP) 16306412.4

(51) Int. Cl. G06Q 20/40; G06Q 20/10; G06Q 20/38; G06Q 30/06; G06Q 30/04

(52) U.S. Cl. CPC G06Q 20/40; G06Q 20/10; G06Q 30/04; G06Q 30/06; G06Q 20/385

(57) ABSTRACT

The invention relates to a method for automatically receiving and/or transmitting information intended for or relating to a holder of an alphanumeric account identifier, the method including a step of creating an electronic address comprising an identifier, wherein the identifier is obtained or derived from at least a portion of the alphanumeric identifier of the account or associated with an account. The invention also concerns the corresponding electronic system.

### TECHNICAL FIELD OF THE INVENTION

The invention concerns a process and system for automatically receiving and/or emitting information relating to transactions carried out by and/or relating to an account number holder, managed by a financial institution or other entity.

The invention concerns more specifically electronic transactions, in particular financial, such as purchases that can be made on line via the Internet on e-commerce websites, locally at retailers using a POS payment terminal (for Point of Sale Terminal), automatic teller machines (ATM), highway terminals, vending machines for goods such as fuel, drinks, etc., company restaurant terminals, store terminals . . .

The invention also concerns the automatic emission of various information from any entity such as commercial or non-commercial companies to account holders.

### PRIOR ART

Such transactions may result in the printing of tickets, receipts or invoices containing information generally corresponding to the details of the transactions. However, the information may include any different kind of data (or information) useful to the user. This data may be necessary as evidence of purchase for a refund, a return of merchandise, an expenditure statement or an account balance or provisioning balance, loyalty points, etc.

This data or information. relating to an account in the broad sense (banking, loyalty, access . . . ) can be managed locally by a computer or remotely by a communicating computer server dedicated to this purpose.

For example, in an ATM terminal, a customer may view his/her latest banking transactions, perform a bank transfer, view the balance of his/her account and obtain, for reference, a paper ticket with a printout of the desired or consulted information.

At a retailer's or in a restaurant, a customer can obtain a receipt (or an invoice) containing the information relating to his/her purchase of a product or service as well as a printed receipt of the bank transaction intended to be kept as evidence.

In addition, it is known that such invoice (or receipt) information may be received directly in electronic form on a messaging address of the customer, which has been previously registered by the customer at the retailer's or other service provider's. This method requires an account creation operation, which may be cumbersome for a user or customer.

In addition, the customer is immediately identified at each transaction by the retailer site to the extent that its name may be associated to his/her credit card number and email address. The customer thus loses anonymity in his/her operations with the retailer site.

The patent application US2016012550 concerning electronic receipts is also known. It describes a process for using email addresses specific to one of domain. Thus, for example, it describes the following«jane.doe@filtroe.com» addresses including the name of a user “jane.doe” associated with a messaging domain name “filtroe.com”. The domain name is controlled by a service provider or an entity collecting the electronic receipts and performing their treatment and display.

However, this process has the disadvantage of requiring the user to register with the above entity. It also requires the user to previously state his/her email address to the shopkeeper or retailer, whether local or remote on the Internet.

Alternatively to prior art solutions, including in particular the one relating to the creation of an account at an e-commerce site on the Internet, the inventors thought of storing a user's e-mail address on a credit card. This address could be stored by a card issuer (manufacturer of smartcards) during a customization step ordered by the organization issuing the credit cards.

The customization could also include the registration of an email or electronic address of the user that is collected from him/her beforehand. An electronic address, or email address, is a chain of characters allowing e-mail to be received in a computer mailbox.

The customization step can be graphic and/or electric. It can be used to emboss the surface of the card with the credit card number (CCN) including the “PAN” number (Primary Account Number), to print a CW code, to encode a magnetic strip, to record a secret code number on the card chip, as well as other data, encryption keys, surname and first name of the user for whom the card is intended, duration of validity of the card, etc.

On the other hand, this method for customizing the email address has the following disadvantages. It requires an additional step of collecting the address information from the user (or holder) of the transaction card and a further customization step. In addition, the user can be reluctant to give information about an email address or if, at any time, he does not wish to receive his electronic receipts by e-mail.

In addition, the user may wish to open that electronic receipt service later and this will no longer be possible or easy with the card, once it has been customized. This method cannot be applied to existing cards distributed in the field.

Another problem is the change of email address by the customer. In this case, it is no longer possible for the customer to receive electronic receipts, the card having stored another address during a customization and/or initialization step.

The patent application US 2014 0229348 Al describes a process for the management of electronic invoices. It includes a step of storing a customer's electronic invoice in an on line database; a step of associating a customer's mobile phone number with the electronic invoice (for example, an assistant of a retailer may request the customer's telephone number and enter it in an association module to the invoice); a step of storing said association in the on line database; a step of generating and associating a single URL with the electronic invoice; and a step of sending the single URL to a mobile device associated with the mobile phone number of the customer via a messaging service.

This process has the disadvantage of requiring the client to disclose his contact information and to lose his anonymity with regard to the retailer or e-commerce site capturing his phone number.

In addition, if the customer changes his phone number, he loses the service continuity of the electronic invoicing.

### TECHNICAL PROBLEM

The purpose of this invention is to solve the above-mentioned disadvantages. The purpose of the invention is to propose a simple and less constraining way allowing a user to receive information relating to any electronic transaction carried out.

The invention also aims to facilitate the issuing of any information to an account holder, whether materialized or not by a card or mobile device.

The invention proposes a simple process in which there is no need to know the address of the user or service supplier in the customization step.

### SUMMARY OF THE INVENTION

The principle of this invention, in its preferred embodiment, provides the automatic generation of email addresses (for emails, or any other web URL address . . . ) with the minimum action from the user. These email addresses can comprise or be derived from all or part of an identifier which is individual or specific to the card (or object of the transaction) itself.

Thus, retailers may attach or send an electronic invoice to a user without knowing his/her private electronic address, telephone number, postal address . . . The user remains anonymous.

Thus, for a credit card, the identifier can be a credit card number including the “PAN” number, the structure of which being defined by the ISO/IEC 7812 standard. The invention may concern others bank account number agreements, or the standard ISO 9362 for SWIFT or ISO 13616 for IBAN. The IBAN code includes generally the BBAN code (Basic Bank Account Account Number) including an IID code (identification of the financial establishment) and a BAN code (bank account number).

The structure of the credit card number generally includes (in the first six digits), a bank identification number (“IIN” code, Issuer identification number or code “BIN” (Bank Identification Number) or SWIFT code). The other digits or number (PAN) allow the bank to identify or retrieve a bank account number of a customer of the bank with which the card is associated.

As an alternative to the “PAN” number, the invention may provide for the use of an identifier comprising or derived from a unique identification number of an electronic chip such as its UID, such as in RFID or contactless cards.

Preferably, the above derivation can be done using a public algorithm or any other secret algorithm (or rule) of the card issuer's choice.

For this purpose, the invention concerns a method for the automatic reception in an electronic address of information intended for or related to a holder of an alphanumeric account identifier (IDT), said method comprising a step of creating an electronic address including an identifier, characterized in that the identifier (IDT) is obtained or derived from at least a part of said account identifier (PAN) or associated to an account (UID).

According to other features:
the IDT identifier is chosen from a number comprising the electronic transaction device number (PAN) or an electronic transaction device chip identifier (UID);
the email address is an email address comprising a user name (NUT) and a domain name (DOM), the user name (NUT) comprising all or part of the identifier (IDT);
the domain name (DOM) can be read by the electronic transaction terminal in a memory of an electronic transaction device;
the domain name (DOM) may correspond to an identifier of a manufacturer of the device or can be deduced from a identification code (IIN) of a card issuer in a card including the (PAN) number;
the domain name (DOM) can be stored specifically in a electronic chip of the transaction device or in a memory of an electronic transaction terminal in association with a transaction application;
the payment terminal can include a program whose instructions are configured to compose an email address from the domain name (DOM) and credit card number comprising at least the (PAN) number and to send information about the transaction performed, at runtime of the instructions by a terminal microcontroller;
a retailer's contactless payment terminal may comprise a program configured to dial an email address from the ID (UID) extracted from a radio frequency chip during a radio frequency transaction and send information about the transaction performed.
At least one email receiving server (Sl, S2) includes a program configured (P2, P3) to extract the identifier from the address of the received email, to find the user by correspondence and to assign or send the electronic receipt to him/her;

in addition, the invention also concerns an electronic system for the automatic reception and/or transmission of information intended or linked to a holder of an alphanumeric account identifier (PAN, UID), said system including a program P1 for creating an email address comprising an identifier. The system is characterized in that the program P1 contains instructions configured to obtain or derive the identifier (IDT) from at least a part of said alphanumeric account identifier (PAN, UID).

According to various embodiments, the system can correspond to or constitute an electronic transaction object or device linked to a user account, such as a smartcard.

Alternatively or in addition, the system can include or be constituted by a transaction terminal or a terminal associated with a central computer managing the transactions or in charge of collecting the funds, particularly from financial institutions.

The above system can preferably integrate a remote or local server managed by a manufacturer of the object and/or a financial organization and/or a telecommunication company or any other of entity.

The program Pl may also reside at least in part in a chip card and/or in a transaction terminal and/or in a server connected to the terminal.

According to other features:
The program (Pl) contains instructions that can be executed by a microcontroller (5), said instructions being configured to extract or obtain the identifier (IDT) among at least part of a number (NDC) including the (PAN) number of the electronic transaction device (10) or an electronic chip identifier (UID) of an electronic transaction device;
the system includes an email receiving server, said server including at least one program P2, P3 configured to extract the identifier (IDT) from the address of the received email, and/or retrieve the user from the identifier (IDT) and a correspondence table Tl, T2 and to forward the electronic transaction information to the user.

The invention has the advantage of offering an immediate service applicable in the field for existing cards or existing accounts.

The account holder remains anonymous to the retailer or other company with which he has carried out an electronic transaction.

The identifier used is already created by an entity managing a customer or user account.

The automatic information reception service is transparent to the customer and without any steps on his part, other than the creation of an account linked to the electronic transaction device.

### BRIEF DESCRIPTION OF THE FIGURES

FIG. 1 illustrates a system according to a preferred embodiment of the invention, which can be divided into several subsystems 1A, 1B, 1C;

FIG. 2 illustrates a credit card showing in particular the identification number of the credit card including the “PAN” number and the “IIN” number also included in the “NDC” credit card number;

FIG. 3 schematically illustrates the hardware or software components of system 1A in FIG. 1, showing a terminal 3 cooperating with a credit card 2;

FIG. 4 schematically illustrates the hardware or software components of the chip 12 of credit card 2;

FIG. 5 illustrates the steps of a method and/or program P1 according to an embodiment of the invention that can be carried out at terminal 3;

FIG. 6 illustrates steps of a complementary method and/or program P2/P3 to the previous program Pl, according to a preferred embodiment of the invention and preferably on a server S1 and/or S2 of a system 1B or 1C of FIG. 1;

### DESCRIPTION

An electronic transaction in the sense of the preferred embodiment of the invention shall be understood mainly as a financial transaction. However, it should also be understood in the broad sense as any communication exchange, leading in particular to physical and/or logical access, access to a transport system, a building, a web site, a telecommunications service, a social security service, a government tax service for civil status identification, driving license, passport . . .

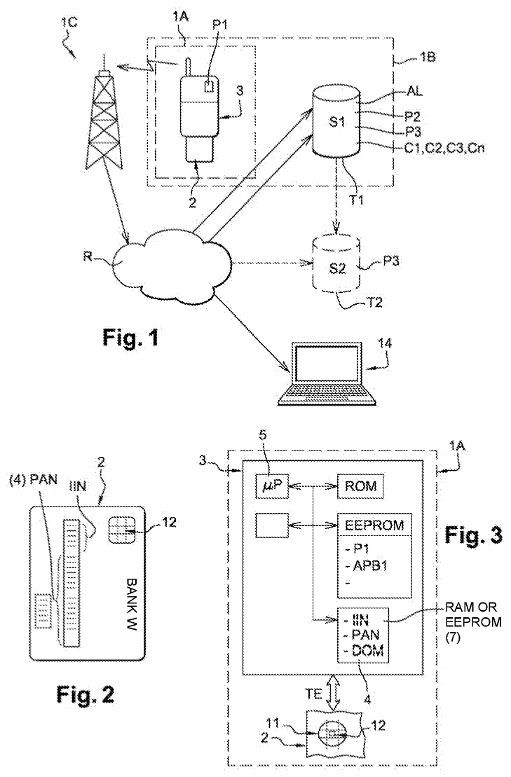

FIGS. 1, 2 and 3 illustrate systems 1A, 1B, 1C according to preferred embodiments of the invention. These systems are intended or configured for the automatic reception of information (1) such as described previously in the introduction. This information may be related or generated during an electronic transaction of the type of those described above.

In the example, the system includes a credit card 2 and a mobile payment terminal 2 (POS) at a retailer's. By definition, the credit card includes a card number comprising a PAN number associated with a bank account of a user.

Alternatively (as described below), the credit card number can be replaced by a single identifier number UID on a chip, for example of a contactless card or transponder (which can be integrated in a watch or other electronic device, or a badge).

Alternatively, the payment terminal (POS) 2 can be replaced by a server (local or remote computer), with direct or remote access via a telecommunication network such as the Internet by different linking protocols such as WIFI, BLUETOOTH, LIFI, proximity radio frequency (NFC). The server can have communication interfaces or access point for exchanging with the transaction device 2.

The information referred to above is intended for (or linked to) a holder of an alphanumeric account identifier (PAN) or a single chip identifier UID associated with a customer or user account. The identifier can include any information, including figures and/or letters and/or signs. Alphanumeric in the sense of the invention includes characters that can either be numerical (0 to 9), or alphabetical (A to Z), or coded by other conventional signs (., §, &, . . . ).

In the example, the information is the information that are officially included in an electronic invoice, in particular the identifier of the seller, of the buyer, the object of the purchase, the amount of the transaction, of the VAT, if applicable, the method of payment, deposit, date, place . . .

In this case, the holder is the holder of an electronic smart card 2. This holder should preferably have a personal electronic messaging address that he/she doesn't wish to disclose to retailers which are accessible via a computer 14.

On the other hand, (without any electronic mailbox, notably a provisional one), the holder has at least one postal address that he/she doesn't wish to disclose either. If necessary, this postal address can replace the email address to allow the forwarding of printed. information or information on memory medium, in particular in the event of a failure of his e-mail system.

Alternatively, the card holder may be the holder of a loyalty card, an account holder, a holder of a credit card with a magnetic strip (without an EMV chip), a holder of an access card to a service provider such as a sports hall, yoga room, parking (with or without microchip), a holder of an identity card, electronic passport or health card.

In some cases, a unique identifier can be visible on a card or any electronic transaction device rather than in a electronic chip.

The identifier 4, in the example, is a PAN number such as the one featured on the front side of credit card 2 (FIG. 2). The PAN number follows the “IIN” number identifying the issuing bank.

Alternatively, the IDT identifier can be created from the complete credit card number. If necessary, it can include, in order to increase the entropy or authentication security of the card, a fixed variable cryptogram number CVV or DCW or any other information on the card.

Preferably, the identifier including the PAN number is closely linked to a support and identifies or authenticates the medium (including a card or other portable object, such as a PAN with regard to a credit card. The connection (or association) to the medium is such that, from the point of view of security, an identifier preferably constitutes, within the meaning of this preferred embodiment, an account ID before being in some cases a holder ID (the account being linked to an account holder). The account can determine the rights of a holder, a credit, a debit, units, an physical right of access to a building, a logical right of access to an on line service provider of various television broadcasts such as movies, games, sports . . .

Alternatively, as indicated, the identifier can be a UID stored in an electronic chip, especially a contactless device. In addition, the UID is preferably associated with a user account in a proximity radio frequency electronic transaction system (NFC, RFID) (access to transport network, sports hall, catering service).

The system 1A, 1B, 1C, according to this preferred embodiment, also includes a program P1 for creating an email address (Email, URL) comprising an identifier;

In the example, the program P1 is included in a program memory of the payment terminal 3.

Alternatively, with respect to the above UID, the program Pl can be included in a program memory of a the mainframe of a fee collection system such as entrance tickets or financial funds for a transport network; the mainframe can be connected, for example, to a set of NFC proximity communication interfaces for monitoring or reading transport fees or tickets.

According to one characteristic of this preferred embodiment, program P1 includes instructions that can be executed by a microcontroller or microprocessor on terminal 3 (or server or mainframe). These computer instructions can be configured to process (use and/or operate and/or extract and/or obtain) the identifier (IDT)) in particular from at least all or part of:
1) a number 4 linked to an account (PAN) or (PAN+IIN) of the electronic transaction device (or card) 2;
2) or an electronic chip identifier (UID) of the electronic transaction device (2).

In the example, the program P1 consists of instructions that can be executed by a microcontroller on the mobile banking terminal 3.

These computer instructions are configured to extract and/or obtain (and/or use and/or exploit) the identifier (IDT)), in particular from at least all or part of the PAN number 4 of the credit card 2. This is explained below in relation to an example of implementation during a payment transaction. The IDT number is extracted during a conventional reading operation of the PAN number (or the credit card number NDC including the IIN and PAN numbers) stored in chip 6 of the credit card 2.

For example, the program P1 can copy or transfer of the PAN number (or IIN+PAN) stored temporarily, after reading, in a buffer memory (RAM) 7 of terminal 3 (or EEPROM 7), before being sent to a financial institution (e.g. materialized by S1 or S2) for updating or authorization of the transaction. The updating of transactions by a financial institution can be effected in real time during the transaction, or deferred over time.

The program P1 can provide an alert signal (flag or other) as soon as the RAM or EEPROM memory (7) is filled with a new number including the PAN. According to program P1, this alert reaches the microcontroller that triggers an extraction of at least the PAN number 4.

The program P1 also includes instructions that allow to then build or create the email address (Email, URL) above.

The invention may provide for one of the following modes of operation. According to one characteristic of a first embodiment, the system (2,3) includes an electronic transaction device 2 (credit card, portable object or device). This device 2 has a chip 12 with an integrated circuit configured to conventionally perform an electronic transaction with the payment terminal 3 by using the credit card number including the PAN number.

According to this first embodiment of the invention, the chip includes also a pre-registered domain name (DOM). This domain name can correspond to the domain name of a server or mainframe computer and/or platform of any service company, in particular the financial department of a bank, and/or a server of a company for customizing credit cards and/or a server of an inserter of banking chip modules.

This domain name DOM can advantageously correspond to a site controlled and/or managed by the inserter and/or manufacturer of the electronic transaction object or device and/or by a customization company.

Thus, thanks to the invention, during a manufacturing phase, when initializing the electronic chips for transaction objects (e.g. cards), it is possible to provide a domain name (DOM) stored from the start in a ROM or EPPROM or flash memory. This domain name may correspond to a name of the manufacturer or customization company or financial institution (IIN) written systematically in the object (e.g. card).

This has the advantage of be free of the prior knowledge of at least one particular domain name of all account holders.

In a more complex form 1B of the system of this invention, according to a preferred embodiment, the system includes a server S1 configured to receive transaction information 1 or information related to an electronic transaction ET. The server S1 can be connected to terminal 3 (and/or the chip) via a telecommunication network R (Internet, Intranet, WiFi, cellular . . . ).

A server S1, S2 generally includes at least one computer with communication interface and computer networking via any communication network, microprocessor-based processing units, program memories and data storage units.

The information can be sent in the form of emails Cl-Cn.

The server S1 (or remote computer) can include a program P2 in a memory program of the server whose computer instructions are configured to identify the user (customer or holder) from the IDT identifier. The user can be found by identifying his/her contact details (name, postal address, e-mail, etc.).

Alternatively, the server S1 can simply perform a minimal operation consisting in receiving the information 1 via emails C1-Cn and store them in the memory at least temporarily.

The system 1C can provide another remote server or computer S2 connected to S1. This second server S2 can be controlled by a financial organization, the server S1 being controlled by the manufacturer of the transaction device. This server S2 can perform, instead of server S1, all or part of the operations performed by server S1 (which can even simply redirect C1-Cn to S2, on request or periodically).

To this end, the program P2 can among other things provide the performance of an extraction step to find the account user, to extract the IDT identifier from each email address C1-Cn and of a step of matching the IDT and the user's (customer's) name via, for example, a correspondence table, to assign or send him/her the information 1.

This financial organization can give access to this server S2 to its customers to allow them to view the information. relating to their various transactions. The server S2 (and/or S1) can be connected to each account holder (user) via a computer 14, or mobile phone, personal assistant (PDA) and the network R to allow him/her any consultation of his/her transaction information and/or emails stored in server S1 and/or S2 or other storage spaces connected to S1 or S2.

The customer can thus access, for example, in a secure way his/her bank account on line (via S2) and select a section for a new service offered by its bank such as “management/viewing of invoices”, “management/viewing of transport passes”.

Various processing options may be offered for this information, these invoices, such as cumulation calculation by retailer, by month, etc. This information can be sorted and processed according to predetermined processing parameters at the customer's choice proposed in S2.

Thanks to the invention, the customer can also opt for the reception/viewing of promotional offers sent by retailers to the e-mail addresses made anonymous to retailers or other entities by the invention.

Alternatively, URLs can be used instead of email addresses. These URLs can be of the anonymous type (without publicity from the URL owner).

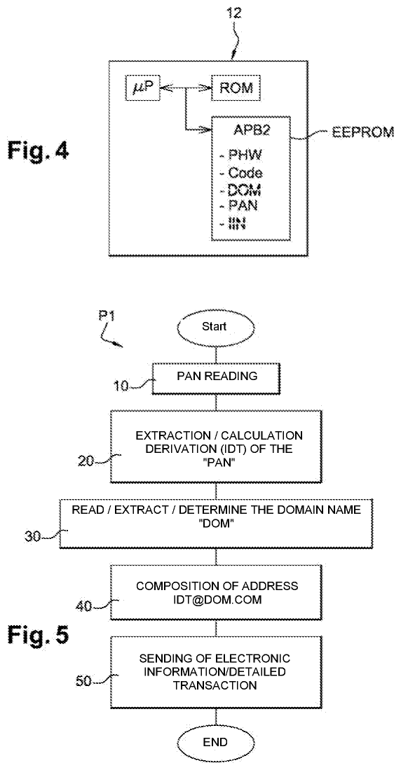

In FIGS. 3 and 4, in a preferred embodiment, an example of the components of chip 12 of the credit card (or device) 2 is shown. The chip is connected to a communication interface with contact area 11. However, a radio frequency interface may be provided.

Chip 12 can typically include an APB2 transaction application, in particular a banking application, preferably an EMV-type of a financial organization.

The chip can include a microprocessor μP, ROMs and EEPROMs, at least one PAN bank account number (or NDC: IIN+PAN) permanently stored, a secret code (Code or PIN Code intended for the transaction to be confirmed by the card holder). The chip can also include, in a preferred embodiment, an Internet domain name “DOM” that may have been stored during an electrical customization step or even before, in a permanent ROM, by a chip manufacturer. Alternatively, the domain name DOM may use all or part of the IIN number (identifying the bank).

In general, in the drawings, alternatives or options for the presence of numbers or information in a memory are indicated by dotted lines as in FIG. 4 or 7.

FIG. 5 shows a flowchart illustrating a preferred method of implementing the steps of a method and/or a program P1 for automatically receiving information 1 at an e-mail address including an identifier (IDT). In this case, the information relates to a purchase in a store using a credit card 2 and a payment terminal 3.

The information is intended for or linked to a holder of an alphanumeric account identifier, in this case a holder of credit card 2. The information corresponds to the content of an invoice.

The flowchart illustrates steps for creating or generating the electronic address (email, URL); in the example (FIG. 5), the method involves creating an email address as follows.
In step 10, the bank account holder has a credit card 2 that is introduced in a POS terminal 3 of a retailer. The credit card number including the PAN number (or IIN+PAN) (linked to a user account), appears on an embossing of the card and in an EMV-certified chip and, as the case may be, on the magnetic strip on the back of the card.

During the conventional EMV transaction, the terminal typically performs a first reading of the PAN number (or a number comprising the PAN: IIN+PAN) stored on the chip. The Credit Card Number “NDC” including the PAN, is equal for example to 3331434288896655 (notably in order to request an authorization for the transaction from the issuing bank).
In step 20, the program P1 of the reader of terminal 3 performs an extraction/calculation or derivation of the credit card number including the PAN. For example, a specific algorithm of the terminal translates the number including the PAN into a modified number, derived from it into number “3331XXXXXXYYYYY6655”.

Alternatively, the above algorithm and/or a number including the modified PAN is stored on chip 12. The latter can be known and stored in a financial institution's server to track successive changes/alterations of the number in the same way as single-use OTP numbers.
In step 30, the program P1 also performs a second reading or extraction or determination of a domain name DOM stored in the EEPROM of chip 12 of the credit card.
In step 40, the program P1 performs a composition of an email address of general structure “IDT@DOM.COM”. To this end, according to one embodiment, terminal 3 then creates the derived number “3331XXXXYYYYY6655” which preferably derives from the NDC number including the PAN (or from the PAN).

Then, the program P1 associates this derived number with a pre-established domain name such as “servicecompany.com” to automatically create the e-mail address below: “3331XXXXYYYY6655@servicecompany.com».

Thanks to the invention, this address is thus intrinsically associated with the card (without referring to a personal user address).

The invention may provide for the following alternatives. Alternatively, the domain name can be stored prior to the transaction in the payment terminal which includes (FIG. 3) an APBl banking application. This domain name DOM can have been downloaded, provisioned or updated remotely with the APBl banking application, notably of the EMV type.

Thus, for each type or issuer of credit card, the invention may provide a specific domain name stored in the payment terminal. The terminal can store, for example, 10 to 50 domain names.

The method may include the following alternative operations. When terminal 3 reads the credit card and recognizes a card issuer (bank W), and the terminal's program P1 then composes the email address from the “PAN” (or derivative such as a token) and the domain name DOM of the previously stored card issuer is recognized by the program P1.

Alternatively, the method can provide an ID reading in the form of an IUD or other intrinsic ID of the card even when applying a predetermined algorithm.
In step 50, the terminal has completed the transaction and, in application of the program P1, it then sends information 1, in this case the corresponding invoice (or electronic receipt with the details of the transaction) in the form of an email C1-Cn or as an attachment to an email C1-Cn, to the email address thus derived ““3331XXXXYYYY6655@servicecompany.com”.

Alternatively, the invoice can be stored in terminal 3 in relation to the email address for later viewing or for a report of all the data at the end of the day or at any other time at the bank and/or server S1 (and/or S2).

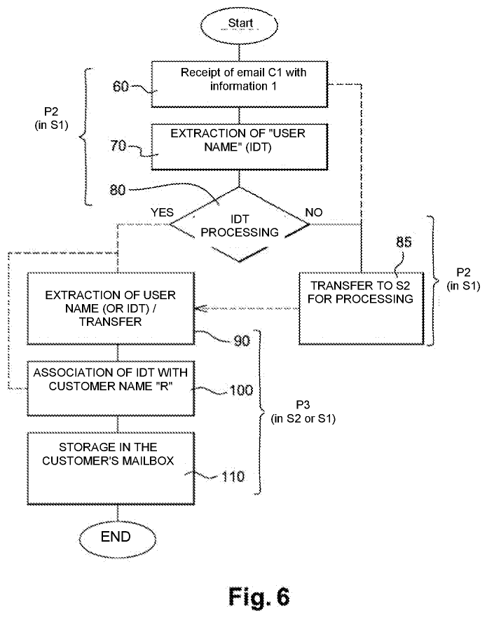

FIG. 6 shows an flowchart describing the receipt and/ou processing of the emails C1-Cn received from terminal 3 according to steps of the method and/or program P2, P3.
In step 60, e-mail C1 is thus received by a mail server S1 in the “DOM” or “servicecompany.com” or “servicebank.com” domain. The program P2 may include instructions (or computer code) configured to receive and/or accept or reject emails according to different criteria or filters.

The criteria include whether the emails correspond or not to a predetermined format or to a valid or invalid email address of a user/customer of the bank.

In case of admission, the server S1 can in turn alternatively process email C1 as required or forward it directly to another server S2 (step 85).
In step 70, program P2 can perform an extraction/determination operation of all or part of the “PAN” account identifier (or preferably the one derived from the actual PAN account number).
In test step 80, program P2 can determine whether S1 provides or not for the IDT identifier processing.

If NO (no processing in S1), P2 can identify the card issuer in particular by comparison in a correspondence table between the names of card issuers (banks) and their identifiers included in the PAN or IDT. Then, P2 in S1 can transfer (transfer branch 85) the email C1-Cn to a server S2 belonging to or possibly controlled by the credit card issuer 3 (bank W). This server S2 then proceeds to the steps 90, 100, 110 of a program P3 that, alternatively, could have been executed by S1.

If YES, (processing in S1), the program P2 moves to the step 90 (or directly to 100 if the operation in step 90 has already been performed at at step 70).

If necessary, the program P2 implements a sub-program or algorithm AL to determine the actual PAN from the derived. PAN.
In step 90, the server S1 can perform the same processing as in step 70 or proceed to step 100 below.
In step 100, the server S1 (or S2) can perform, by running a program P3 contained in it, an association of the email Cl, either with an email address of the card issuer (bank) and/or directly with a mailbox of the customer (or user).

For this purpose, the server S1 (or S2) can include a table of correspondence T2 or equivalent to match the extracted PAN with a customer's personal email address or an address of a banking institution.
In step 110, the emails “Cn” can then be transferred to the customer's mailbox anonymously and be stored there. Then the program ends.

In a general way, the invention provides the functions and/or benefits below.

Advantageously, thanks to the invention, the customer (owner) can view at any time the emails relating to his/her transactions carried out and reported on his/her banking site or server S2 linked to the banking site S2, especially in a mailbox associated with his/her bank account, created automatically at the opening of his/her account by the financial institution.

The customer does not need to have a personal mailbox in addition to the one created by the financial institution. The customer can view his/her purchases via all electronic receipts or invoices received by his/her financial institution, in particular via on line access to a user account, especially a bank account.

Electronic information (receipts or invoices) can be accessible through the implementation of a writing and/or reading access security method or mechanism. Thus for example, they can be stored in encrypted form. A personal code can be requested by the server S2 of the financial institution to make electronic receipts readable.

Alternatively, the user can receive an instruction from the server S2 asking him/her to insert a card or flash drive (or any material device or hardware) containing decryption keys for the emails containing electronic receipts or invoices, made accessible by the financial institution's server.

The user can trigger or use proposed functions of the server S2 for processing or managing the information contained in his/her electronic receipts, such as sorting by date, by amount, by retailer, by period.

Where applicable, the customer, retailer or other entity may receive other types of information (not directly related to its own electronic transactions). For example, it may receive promotional, informative, event information from an entity, with which the customer has performed at least one transaction (or is considering making a transaction in the future).

Similarly, the invention. allows, for any retailer or entity, to emit any type of information and/or communication (promotions, events, invitations, . . . ) to persons of whom it knows an identifier collected during a transaction (and not directly related to the actual electronic transactions of these persons, such as invoices).

The entity only needs to know or to have the algorithm AL from which is composed the email address of a person having a user account. It may be the UID code or the PAN. This algorithm can be stored in a payment terminal and/or a mainframe computer, notably for collecting monetary funds for a transport service.

Alternatively, the entity may send information 1 to be transmitted to a server managed by a third party organization such as a credit card inserter or a financial institution (or any other body in which the user has a financial account (or other, such as loyalty, access . . . ).

The server S1 (or S2) finds the person's address from of the IDT identifiers and if necessary the reverse algorithm AL. Then, a function matching the identifiers with the electronic addresses of the users makes it possible to find the addresses targeted by any entity wishing to send all kinds of information.

The user can authorize or decline this service as an intermediary, in particular by specifying it in server S1 and/or S2 in a field of a server memory dedicated to the preferences of users.

The customer can select this function on the website of his/her financial institution (or other) S2 to authorize or allow a reading of any information from selected retailers or entities.

The customer can refine the type of information of interest to him/her in relation to each retailer or entity. Thus, the financial institution's site or server can serve as a trusted intermediary for a card or electronic transactions account (including financial) customer or user.

In the same way, a customer or user can contact a retailer anonymously by performing the reverse operations of the method steps described above. For example, a customer sends an email requesting information to a retailer via the server S2 (or S1) which transmits it to the retailer anonymously by replacing the customer's email address by an address composed of the PAN (or a derivative of the PAN) and the domain name of the server S2 (or S1).

The site or server of the financial institution allows a filter to be made or to block information, on customer or user choice.

The site or server S1 or S2 allows to organize, process, operate the entirety of the available information received from retailers or other entities. For example, the site offers a display of the available information on a table such as an Excel spreadsheet.

Thus, anonymity of the user with regard to each e-commerce site is preserved.

In addition, there is no additional operation to create an account with each retailer, nor any registration process with a third party server or entity managing an information processing service (with the exception of the financial institution managing the account, already holding, at the opening of the bank account, identification and contact data, by mailbox).

This intermediate server S1 can be proposed as a service by a service company to the card issuer (financial institution). The service company can be the credit card inserter or the company performing the electrical and/or graphic customization of the card.

The invention can similarly be applied to contactless transport transactions. The transaction consists, for example, in allowing access using an access door terminal to a transport network.

According to this alternative relating to the UID, or unique chip identifier, the holder presents his contactless object to an access reader. The object has a contactless function (card without contact, electronic bracelet, mobile phone with contactless card emulation, any portable object, RFID ticket).

Once the operation is completed, the local or centralized transport system composes in much the same way as for the PAN, an email Cl whose user name is derived from or includes all or part of the IUD number stored in the contactless chip. For the domain name, the system recognizes the type of the chip in question, as well as the communication protocol and the issuer of the object.

The transport system can read a domain name DOM, either pre-set in the chip in the UID, or stored in a local or central computer of the system.

The transport system composes the email in much the same way as for the PAN and sends an electronic invoice or receipt to the address thus composed.

1. A method for automatically receiving information intended for or related to a holder of an alphanumeric account identifier, said method comprising a step of creating an electronic address including an identifier, wherein the identifier is obtained or derived from at least a portion of said alphanumeric account identifier or associated to an account.

2. The method according to claim 1, wherein said identifier is selected from an electronic transaction device number or an electronic transaction device chip identifier.

3. The method according to claim 1, wherein the electronic address is an electronic mail address comprising a user name and a domain name, the user name comprising all or part of the identifier.

4. The method according to claim 3, wherein the domain name in an electronic transaction device is readable by an electronic transaction terminal.

5. The method according to claim 3, wherein the domain name corresponds to an identifier of a device manufacturer or is derived from an identification code of a card issuer in a card number including the account number.

6. The method according to claim 3, wherein the domain name is specifically stored in a chip of an electronic transaction device or in a memory of an electronic transaction terminal in association with a transaction application.

7. The method according to claim 4, wherein the payment terminal comprises a program whose instructions are configured to compose an electronic address from the domain name and a credit card number including at least the transaction device number and to send information about the transaction, once completed.

3. The method according to claim 3, wherein a contactless payment terminal of a retailer includes a program configured to dial an email address from the identifier extracted from a radio frequency chip during a radio frequency transaction and to send information about the transaction, once completed.

9. The method according to claim 1, wherein at least one server receiving emails includes a program configured to extract the identifier from the address of a received email, to find the user by correspondence and assign or send him/her the electronic receipt.

10. An electronic system for the automatic reception and/or transmission of information intended for or related to a holder of an alphanumeric account identifier, said system comprising a program for creating an electronic address including an identifier,
wherein the program P1 contains instructions executable by a microcontroller and configured to obtain or derive the identifier from at least a part of said alphanumeric account identifier.

11. The system according to claim 10, wherein said program contains instructions executable by a microcontroller, said instructions being configured to extract or obtain the identifier from at least a portion of a card number comprising at least an electronic transaction device number or an electronic transaction device chip identifier.

12. The system according to claim 11, wherein the electronic transaction device comprises an integrated circuit chip configured to carry out an electronic transaction and a payment terminal comprising said program for carrying out a transaction with said device by using a credit card number comprising at least the alphanumeric account identifier, said chip comprising a pre-registered domain name.

13. The system according to claim 12, further comprising an email receiving server, said server comprising a program configured to extract the identifier from the address of the received email, and/or to retrieve the user from the identifier and a correspondence table and to send to the user electronic transaction information.
